(19) United States
(12) Patent Application Publication
(10) Pub. No.: US 2015/0108939 A1
(43) Pub. Date: Apr. 23, 2015

(54) PHOTOVOLTAIC CONTROLLER AND METHOD FOR PHOTOVOLTAIC ARRAY

(71) Applicant: Neldon P. Johnson, Deseret, UT (US)

(72) Inventor: Neldon P. Johnson, Deseret, UT (US)

(21) Appl. No.: 14/061,731

(22) Filed: Oct. 23, 2013

(51) Int. Cl. H02J 7/35; H02J 7/34

(52) U.S. Cl. CPC H02J 7/35; H02J 7/345
USPC 320/101

(57) ABSTRACT

A photovoltaic controller for a photovoltaic array of photovoltaic cells. The photovoltaic controller incorporates a capacitor charge circuit electrically connected to each photovoltaic cell, cell capacitors connected to each photovoltaic cell by the capacitor charge circuit, capacitor charge switches, a capacitor discharge circuit electrically connected to each cell capacitor, an output circuit connected to the capacitor discharge circuit, capacitor discharge switches, a plurality of capacitor voltage sensors, and a photovoltaic control module in communication with the capacitor voltage sensors, the capacitor charge switches and the capacitor discharge switches.

### BACKGROUND

This invention is in the field of electrical controllers for photovoltaic systems and in the particular in the field of automated electronic controls and method for controlling voltage and current of photovoltaic arrays.

Photovoltaic systems typically consist of one or more arrays of photovoltaic cells, electrical connections, charge storage elements or direct current (DC) to alternating current (AC) conversion elements or both, and control elements for a charge, i.e. current, produced by the photovoltaic cells. Each photovoltaic array comprises a plurality of photovoltaic cells.

The photovoltaic cells of a photovoltaic array convert electromagnetic radiation, including visible light, and typically portions of the ultraviolet spectrum and the near infrared spectrum, into a DC current. This is accomplished by irradiating the photovoltaic cells with sunlight, the photons of sunlight being absorbed by the photovoltaic cells, and the photovoltaic cells releasing electrons, thereby generating a current. Depending upon the extent of the array of the photovoltaic cells and the nature of the electrical circuit to which the photovoltaic cell or the photovoltaic array as a whole is connected, a photovoltaic cell may typically generate between 0 and 0.5 volts. The photovoltaic cell will continue to produce electrons while being irradiated by sunlight so long as the voltage of the circuit to which the photovoltaic cell is discharging electrons does not exceed a shut down voltage (Vₛ). For instance, if a photovoltaic cell is connected to a capacitor, upon being irradiated by sunlight, the photovoltaic cell will produce electrons which will flow into the capacitor and the electrons will continue to flow until the voltage across the capacitor electrodes is equal to the Vₛ for the photovoltaic cell.

As is illustrated by FIG. 1, the instantaneous current (I) generated by the photovoltaic cell and flowing from the photovoltaic cell will be dependent upon the extent of the irradiation of the photovoltaic cell, the characteristics of the photovoltaic cell, and the instantaneous voltage (V) of the circuit to which the current is being discharged by the photovoltaic cell. The formula for the instantaneous power (P) generated by the photovoltaic cell may be determined by the formula P=I*V. The I and V values at which the maximum power (Pₘₐₓ) is generated are I=Iₘₚ and V=Vₘₚ respectively. I is at its maximum (I₀ᵥ) when the voltage in the circuit to which the photovoltaic cell is being discharged is zero. In the case of a photovoltaic cell producing charge that is stored in a capacitor, the maximum current occurs when there is no charge on the capacitor. As the V to which the photovoltaic cell is subjected by the capacitor charging circuit, increases above Vₘₚ, the current produced by the photovoltaic cell decreases rapidly and goes to zero at the voltage reaches the shut off voltage (Vₛ). During any time period that V in the circuit to which the photovoltaic cell or the photovoltaic array as a whole, is discharging current, exceeds Vₘₚ, the efficiency of the photovoltaic cell or photovoltaic array as a whole will be significantly diminished.

Considerable effort has been made over the last decade or so to improve the design and the efficiency of photovoltaic systems, and to reduce the cost. Efficiencies less than ten percent (10%) have been common to date. As a result, the cost per watt of maximum power output and the cost per kilowatt hour for power generated has been high in comparison to the cost of power generated from the burning of fossil fuels. The extent of the effort made in recent years to improve the efficiency of photovoltaic systems is evidenced by the number of prior art devices and methods. These methods and devices have met with varying degrees of success.

Energy from a photovoltaic system is generally stored in batteries for later use or converted to an AC current for discharge to an electrical grid. If the energy is to be stored in a battery, the voltage for the photovoltaic system will have to be adjusted to exceed the transient voltage of the battery. Since the maximum voltage output of a photovoltaic cell is typically on the order of 0.5 volts, the voltage must be stepped up before the energy can be stored in a battery system. Similarly, if the energy generated by a photovoltaic cell is to be discharged to an electrical grid system, which may be operated at 240 volts, 480 volts, or much higher voltages, the voltages must be stepped up to a voltage exceeding the minimum voltage required by an inverter which will invert the DC current to a pulsed AC current. Various filters may then be used to impose a sinusoidal wave form on the AC. Depending upon the operating voltage of the grid to which the photovoltaic energy is to be discharged, a transformer may be used to further step up the voltage.

An objective of the present invention is to provide a voltage and current controller for a photovoltaic array, alternatively referred to herein as a “photovoltaic controller”, which provides for the continuous production of current by each of the irradiated photovoltaic cells of a photovoltaic array regardless of the level of irradiation.

A further objective of the device and method of the present invention is to provide for the continuous production of current by a photovoltaic array by avoiding increasing the voltage of the discharge circuit, at each of the photovoltaic cells, above Vₘₚ.

A further objective of the present invention is to provide for the continuous and optimized production of energy by each of the photovoltaic cells of a photovoltaic array while simultaneously stepping up the voltage of an aggregate current discharged by the full photovoltaic array to a level required for discharge to an inverter or to a DC battery storage system, or both.

### SUMMARY OF THE INVENTION

A preferred embodiment of the photovoltaic controller of the present invention incorporates a capacitor network comprised of a plurality of capacitor banks. Each photovoltaic cell of the photovoltaic array is electrically connected to a capacitor bank by a capacitor charge circuit. Each photovoltaic cell has a cell anode, which is a source of positive charge, and a cell cathode, which is a source of negative charge for the current generated by the photovoltaic cell during irradiation. Each capacitor bank, for a preferred embodiment of the photovoltaic controller, comprises three cell capacitors, a first cell capacitor, a second cell capacitor, and a third cell capacitor. Each capacitor has two capacitor electrodes, a capacitor anode which accumulates a positive charge and a capacitor cathode which accumulates a negative charge. A capacitor voltage sensor is connected to each cell capacitor and continuously monitors the voltage across the capacitor.

When the photovoltaic cell is being irradiated by solar radiation, a first capacitor first charge switch and first capacitor second charge switch of the capacitor charge circuit may be closed by the control module, which allows a current to flow by the capacitor charge circuit from the photovoltaic cell to the first cell capacitor. When the photovoltaic control module determines, based upon the voltage sensed by the first voltage sensor, that the voltage across the first cell capacitor equals or exceeds a desired target maximum voltage, which may be for example be Vₘₚ or 80% of Vₘₚ, the first capacitor first charge switch and first capacitor second charge switch are opened, and the first capacitor first discharge switch and the first capacitor second discharge switch of the capacitor discharge circuit are closed. A second capacitor first charge switch and a second capacitor second charge switch of the capacitor charge circuit are closed, and a second capacitor first discharge switch and a second capacitor second discharge switch are open, thereby providing for a current to flow by the capacitor discharge circuit to the output circuit from the first cell capacitor while current flows by the capacitor charge circuit from the photovoltaic cell to the second cell capacitor, providing for uninterrupted current production by the photovoltaic cell.

When the voltage across the second cell capacitor equals or exceeds the desired target maximum voltage, the second capacitor first charge switch and the second capacitor second charge switch are opened, disconnecting the second cell capacitor from the photovoltaic cell, and a second capacitor first discharge switch and a second capacitor second discharge switch are opened, connecting the second cell capacitor to the output circuit. The third cell capacitor is connected to the photovoltaic cell by a third capacitor first charge switch and a third capacitor second charge switch, again providing for the uninterrupted production of current by the photovoltaic cell. When the voltage across the third cell capacitor equals or exceeds the desired target maximum voltage, the third capacitor first charge switch and the third capacitor second charge switch are opened, disconnecting the third cell capacitor from the photovoltaic cell, and the third capacitor first discharge switch and the third capacitor second discharge switch are opened, connecting the third cell capacitor to the output circuit. The first cell capacitor may be connected to the photovoltaic cell and the cycle is started again.

The process of the selective and sequential charging and discharging of the respective cell capacitors of each photovoltaic cell may thus be controlled by the control module, based upon the voltage monitored by the voltage sensors. The control module may cycle between the cell capacitors based upon the level of irradiation of the photovoltaic cell, the resultant current production of the photovoltaic cell, and the voltages across the cell capacitors as measured by the voltage sensors.

For a preferred embodiment, the control module may maintain the discharge switches, from the cell capacitor being discharged to the output circuit, open until the voltage across the cell capacitor, as measured by a voltage sensor, is zero or a selected minimum, until the charge switches for the cell capacitor are opened by the control module, or until other such time or event as may be determined by a control algorithm.

The use of the three capacitors, the first cell capacitor, the second cell capacitor, and the third cell capacitor, for most photovoltaic arrays, provides for the availability of an adequately discharged photovoltaic capacitor for the receipt of current from the photovoltaic cell when one or both of the other photovoltaic cell capacitors are still discharging current to the output circuit. However, simplified embodiments may utilize only two photovoltaic cell capacitors and others may use four or more for each photovoltaic cell. The number required will depend on the number needed to provide for adequate cycling of charging and discharging, so that the photovoltaic cell may achieve reasonably efficient and reasonably continuous production of current by the photovoltaic cell.

The output circuit provides for the photovoltaic cell capacitor discharge output for each of the photovoltaic cells to be connected in series. If, for example, (a) the photovoltaic array were to comprise 1200 photovoltaic cells; (b) the charging and discharging of the cell capacitors are controlled by the control module; (c) the voltage of the photovoltaic cell capacitors, during discharge, varies between 0.0 and 0.4 volts; and (d) approximately one half of the cell capacitors are discharging to the output circuit at all times, the total voltage output at the photovoltaic array output for the photovoltaic cells connected in series will be approximately 120 volts DC. The DC current may be input to an inverter which will generate a pulse alternating current with a voltage of approximately 120 volts AC. The inverter current output may be input to a filter which will impose a sinusoidal waveform on the AC current. The control module may be programmed to control the photovoltaic capacitor switches so as to maintain a photovoltaic array output voltage within a desired target range for an inverter or batteries.

### BRIEF DESCRIPTION OF THE DRAWINGS

FIG. 1 is a illustration of the relationship between the voltage in the discharge circuit and the current flowing from a photovoltaic cell.

FIG. 2 is a schematic of a preferred embodiment of a photovoltaic controller of the present invention connected to a photovoltaic array.

FIG. 3 is schematic detail of a preferred embodiment of a photovoltaic controller cell element of a preferred embodiment of a photovoltaic controller of the present invention connected to a photovoltaic cell.

### DETAILED DESCRIPTION

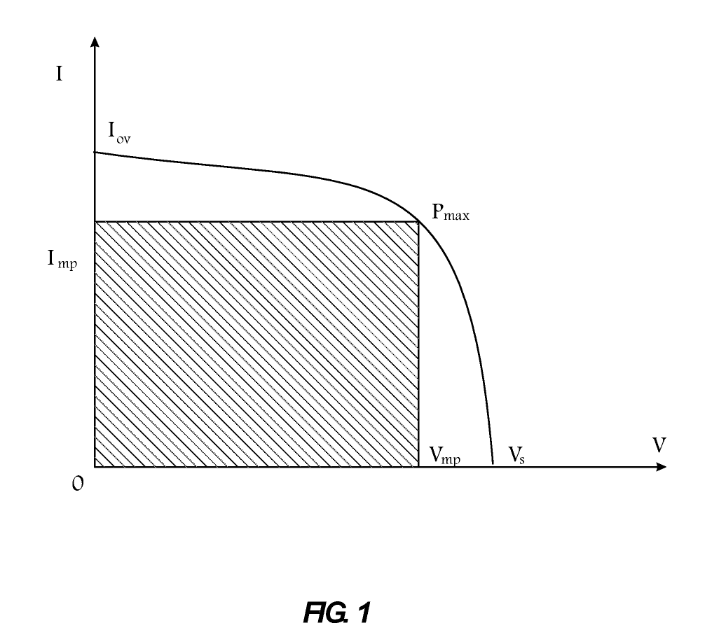

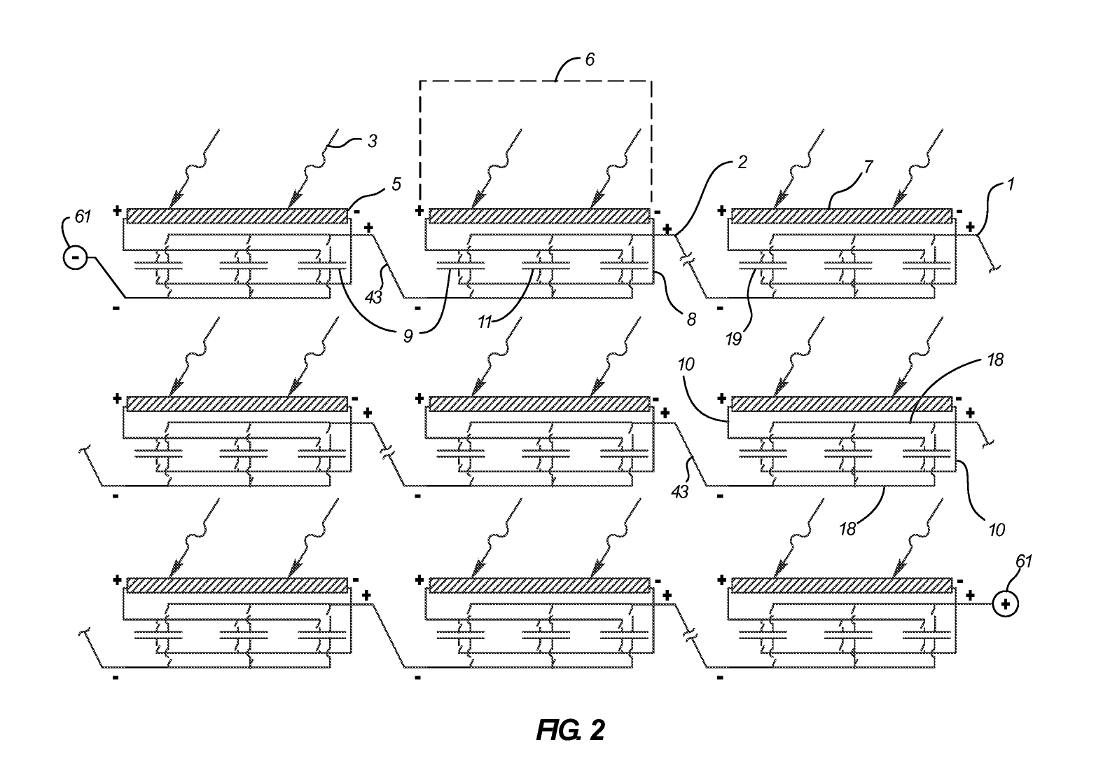

Referring first to FIG. 2 a schematic of a preferred embodiment of a photovoltaic controller 1 of the present invention is shown. For the embodiment shown, solar radiation 3, which may include visible light and portions of the ultraviolet spectrum and the infrared spectrum, is incident to the photovoltaic array 5. The photovoltaic array 5 is comprised of a plurality of photovoltaic cells 7. The photons of the solar radiation 3 strike the absorption medium in each of the photovoltaic cells 7, thereby resulting in the release of electrons by the absorption medium of the photovoltaic cell 7. The resultant current (I) will continue so long as the receiving voltage (V) 6 of the receiving circuit 8 at the photovoltaic cell 7 is less than the shut down voltage (Vₛ), as shown in FIG. 1, and so long as the photovoltaic cell 7 is being irradiated by incident solar radiation 3. As stated above, a typical value for Vₛ is 0.5 volts and a typical value for Vₘₚ, is 0.4 volts.

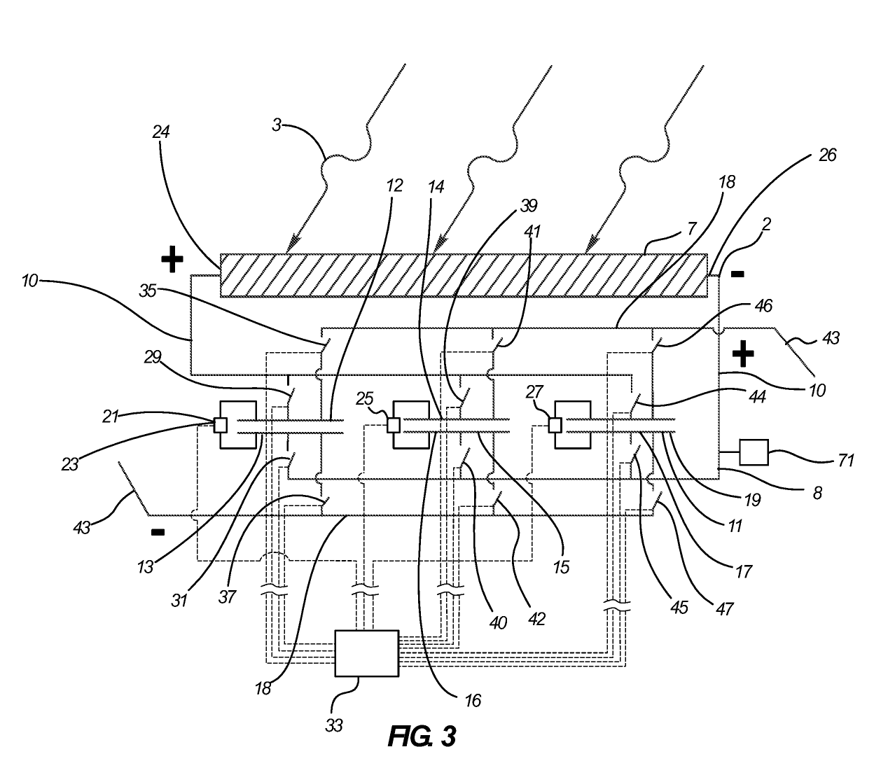

For the preferred embodiment of the photovoltaic controller 1 shown in FIG. 2, there is a capacitor network 9 comprised of a plurality of capacitor banks 11. Referring also to FIG. 3, each photovoltaic cell 7 of the photovoltaic array 5 is electrically connected to a capacitor bank 11 by a capacitor charge circuit 10. Each photovoltaic cell has a cell anode 24, which is a source of positive charge, and a cell cathode 26, which is a source of negative charge for the current generated by the photovoltaic cell during irradiation. FIG. 3 is a schematic detail of a preferred embodiment of a photovoltaic controller cell element 2 of a preferred embodiment of a photovoltaic controller 1 of the present invention connected to a photovoltaic cell 7. Each capacitor bank 11, for the preferred embodiment of the photovoltaic controller 1 shown in FIG. 2 and FIG. 3, comprises three cell capacitors 19, a first cell capacitor 13, a second cell capacitor 15, and a third cell capacitor 17. Each capacitor has two capacitor electrodes 12, a capacitor anode 14 which accumulates a positive charge and a capacitor cathode 16 which accumulates a negative charge. A capacitor voltage sensor 21 is connected to each cell capacitor 19 and continuously monitors the voltage across the capacitor 19. For the embodiment shown, each capacitor bank 11 has a first voltage sensor 23 monitoring the voltage across the first cell capacitor 13, a second voltage sensor 25 monitoring the voltage across the second cell capacitor 15, and a third voltage sensor 27 monitoring the voltage across the third cell capacitor 17.

Referring to FIG. 3, when the photovoltaic cell 7 is being irradiated by solar radiation 3, the first capacitor first charge switch 29 and first capacitor second charge switch 31 of the capacitor charge circuit 10 may be closed by the control module 33, which allows a current to flow by the capacitor charge circuit 10 from the photovoltaic cell 7 to the first cell capacitor 13. When the photovoltaic control module 33 determines, based upon the voltage sensed by the first voltage sensor 23, that the voltage across the first cell capacitor 13 equals or exceeds a desired target maximum voltage, which may be for example be Vₘₚ or 80% of Vₘₚ, the first capacitor first charge switch 29 and first capacitor second charge switch 31 are opened, and the first capacitor first discharge switch 35 and the first capacitor second discharge switch 37 of the capacitor discharge circuit 18 are closed. A second capacitor first charge switch 39 and a second capacitor second charge switch 40 of the capacitor charge circuit 10 are closed, and a second capacitor first discharge switch 41 and a second capacitor second discharge switch 42 are open, thereby providing for a current to flow by the capacitor discharge circuit 18 to the output circuit 43 from the first cell capacitor 13 while current flows by the capacitor charge circuit 10 from the photovoltaic cell 7 to the second cell capacitor 15, providing for uninterrupted current production by the photovoltaic cell 7.

When the voltage across the second cell capacitor 15, as monitored by the second voltage sensor 25 equals or exceeds the desired target maximum voltage, the second capacitor first charge switch 39 and the second capacitor second charge switch 40 are opened, disconnecting the second cell capacitor 15 from the photovoltaic cell 7, and a second capacitor first discharge switch 41 and a second capacitor second discharge switch 42 are opened, connecting the second cell capacitor to the output circuit 43. The third cell capacitor 17 is connected to the photovoltaic cell 7 by a third capacitor first charge switch 44 and a third capacitor second charge switch 45, again providing for the uninterrupted production of current by the photovoltaic cell. When the voltage across the third cell capacitor 17, as monitored by the third voltage sensor 27, equals or exceeds the desired target maximum voltage, the third capacitor first charge switch 44 and the third capacitor second charge switch 45 are opened, disconnecting the third cell capacitor 17 from the photovoltaic cell 7, and the third capacitor first discharge switch 46 and the third capacitor second discharge switch 47 are opened, connecting the third cell capacitor to the output circuit 43. The first cell capacitor 13 may be connected to the photovoltaic cell 7 and the cycle is started again.

The process of the selective and sequential charging and discharging of the respective cell capacitors 19 of each photovoltaic cell 7 may thus be controlled by the control module 33, based upon the voltage monitored by the first voltage sensor 21, the second voltage sensor 23, and the third voltage sensor 25. The control module may cycle between the cell capacitors 19 based upon the level of irradiation of the photovoltaic cell 7, the resultant current production of the photovoltaic cell 7, and the voltages across the cell capacitors 19 as measured by the voltage sensors 21, 22, 23.

For a preferred embodiment, the control module 33 may maintain the discharge switches, from the cell capacitor 19 being discharged to the output circuit 43, open until the voltage across the cell capacitor 19, as measured by a voltage sensor, is zero or a selected minimum, until the charge switches for the cell capacitor 19 are opened by the control module 33, or until such other time or occurrence as may be determined in accordance with a control algorithm.

The use of the three capacitors, the first cell capacitor 13, the second cell capacitor 15, and the third cell capacitor 17, for most photovoltaic arrays 5, provides for the availability of an adequately discharged photovoltaic capacitor for the receipt of current from the photovoltaic cell 7 when one or both of the other photovoltaic cell capacitors are still discharging current to the output circuit 43. However, simplified embodiments may utilize only two photovoltaic cell capacitors for each photovoltaic cell, and, for most applications, this will provide for adequate cycling of charging and discharging, so that the photovoltaic cell may achieve reasonably efficient and reasonably continuous production of current by the photovoltaic cell. Similarly, more complex and even more efficient embodiments may utilize four or more photovoltaic cell capacitors for each photovoltaic cell. While the embodiment shown in FIG. 2 and FIG. 3 with three photovoltaic cell capacitors 19 is believed by the applicant to provide adequate operational flexibility and efficiency for most applications, other applications may dictate the use of only two photovoltaic cell capacitors and other applications may dictate the use of four or more photovoltaic cell capacitors.

Referring again to FIG. 1, it will be noted that the output circuit 43 provides for the photovoltaic cell capacitor discharge output for each of the photovoltaic cells to be connected in series. Assuming, for example, that the photovoltaic array 5 comprises 1200 photovoltaic cells, all of cell capacitors 19 of which are voltage monitored, and the charging and discharging of the cell capacitors are controlled by the control module 33. Assuming further that if the voltage of the photovoltaic cell capacitors 19, during discharge, varies between 0.0 and 0.4 volts, and that approximately one half of the cell capacitors are discharging to the output circuit 43 at all times, the total voltage output at the photovoltaic array output 61 for the photovoltaic cells connected in series will be approximately 120 volts DC. The DC current may be input to an inverter which will generate a pulse alternating current with a voltage of approximately 120 volts AC. The inverter current output may be input to a filter which will impose a sinusoidal waveform on the AC current. Similarly, the control module can be programmed to control the photovoltaic capacitor switches so as to maintain a photovoltaic array output voltage 61 within a desired target range so as to be compatible with the needed output of an attached inverter. Similarly, the voltage may be controlled by the control module 33 to maintain a photovoltaic array output voltage that will provide for the charging of one or more batteries attached to the photovoltaic array output 61.

It is anticipated, based upon current technology, that the capacitors, switches, voltage sensors, and circuit connections between these components, will be components of an integrated circuit in which the photovoltaic cells are imbedded. The utilization of additional capacitors, switches and voltage sensors for embodiments with a larger number of capacitors for each photovoltaic cell, would certainly increase the cost of the photovoltaic controller of the present invention.

For alternative preferred embodiments of the present invention, the interconnection between the voltage sensors and the control module 33 may be wireless. Similarly, the interconnection between the control module 33 and the switches may be wireless.

For preferred embodiments, the control module 33 may receive continuous voltage measurements, or voltage measurements made at intervals, from the voltage sensors of each photovoltaic cell 7 of the photovoltaic array 5, and use the voltage data to control the switches so as to attempt to optimize the output power production for the photovoltaic array 5, while providing for connecting the discharge output of each photovoltaic cell 7 to the output circuit 43. The current (I) flowing from each photovoltaic cell 7 may also be measured continuously, or at intervals, by a cell current sensor 71, and the current data transmitted to the control module 33. This current data may be used, along with the voltage data, by the control module 33 to attempt to optimize the output power production for the photovoltaic array 5.

For a preferred embodiment, the control module 33 may incorporate a digital computer and may communicate by wire or wireless with the capacitor voltage sensors to receive voltage measurements and may communicate by wire or wireless with the charge switches and the discharge switches to cause the switches to open and close as needed to manage the charging and discharging of the photovoltaic cell capacitors 19 so as to optimize the energy extraction of the photovoltaic array 5 and to control the voltage and other characteristics of the output from the photovoltaic array output 61 so as to appropriately interface with storage, electric grid or other application for the extracted solar energy.

In view of the disclosures of this specification and the drawings, other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. A photovoltaic controller for a photovoltaic array of a plurality of photovoltaic cells, each photovoltaic cell having a cell anode and a cell cathode, the photovoltaic controller comprising:
a capacitor charge circuit electrically connected to each photovoltaic cell;
a plurality of respective cell capacitors connected to the photovoltaic cell by the capacitor charge circuit, each cell capacitor having two capacitor electrodes, a capacitor cathode and a capacitor anode;
a plurality of capacitor charge switches, a respective capacitor charge switch being electrically connected in the capacitor charge circuit between the cell cathode and the capacitor cathode of a respective cell capacitor, and a respective capacitor charge switch being electrically connected in the capacitor charge circuit between the cell anode and the capacitor anode of a respective cell capacitor;
a capacitor discharge circuit electrically connected to each cell capacitor;
an output circuit connected to the capacitor discharge circuit;
a plurality of capacitor discharge switches, a respective capacitor discharge switch being electrically connected in the capacitor discharge circuit between the capacitor cathode of a respective cell capacitor and the output circuit, and a respective capacitor discharge switch being electrically connected in the capacitor discharge circuit between the capacitor anode of a respective cell capacitor and the output circuit;
a plurality of capacitor voltage sensors, each of the voltage sensors being electrically connected to a respective cell capacitor;
a photovoltaic control module in communication with the capacitor voltage sensors, the capacitor charge switches and the capacitor discharge switches.

2. The photovoltaic controller recited in claim 1 further comprising a cell current sensor electrically connected to the capacitor charge circuit, the cell current sensor being in communication with the photovoltaic control module.

3. The photovoltaic controller recited in claim 1 wherein the photovoltaic control module controls the capacitor charge switches, the capacitor discharge switches, and the charging and discharging of the cell capacitors.

4. The photovoltaic controller recited in claim 1 wherein the photovoltaic control module incorporates a digital computer with a control algorithm.

5. A method for optimizing the output power production of a photovoltaic array of a plurality of photovoltaic cells, each photovoltaic cell having a cell anode and a cell cathode, the method comprising:
connecting a plurality of respective cell capacitors by a capacitor charge circuit to each photovoltaic cell by a capacitor charge circuit, each cell capacitor having two capacitor electrodes, a capacitor cathode and a capacitor anode;
using a plurality of capacitor charge switches to selectively charge the respective cell capacitors, a respective capacitor charge switch being electrically connected in the capacitor charge circuit between the cell cathode and the capacitor cathode of a respective cell capacitor, and a respective capacitor charge switch being electrically connected in the capacitor charge circuit between the cell anode and the capacitor anode of a respective cell capacitor;
monitoring a capacitor voltage across each cell capacitor using a plurality of voltage sensors, one of the respective voltage sensors being electrically connected to a respective cell capacitor;
connecting the cell capacitors to an output circuit by a capacitor discharge circuit;
using a plurality of capacitor discharge switches to selectively discharge the respective cell capacitors, a respective capacitor discharge switch being electrically connected in the capacitor discharge circuit between the capacitor cathode of a respective cell capacitor and the output circuit, and a respective capacitor discharge switch being electrically connected in the capacitor discharge circuit between the capacitor anode of a respective cell capacitor and the output circuit;
using a photovoltaic control module in communication with the capacitor voltage sensors, the capacitor charge switches, and the capacitor discharge switches, to control an operation of the respective capacitor charge switches and an operation of the respective capacitor discharge switches, to optimize the power output of the photovoltaic array using the capacitor voltages measured by the voltage sensors.

6. The method recited in claim 5 further comprising measuring a current from each photovoltaic cell using a respective cell current sensor electrically connected to the capacitor charge circuit, each of the cell current sensors being in communication with the photovoltaic control module, and the photovoltaic control module using the measured current for each photovoltaic cell in controlling the operation of the capacitor charge switches and the operation of the capacitor discharge switches in optimizing the power output of the photovoltaic array.

7. The method recited in claim 5 wherein the photovoltaic control module controls the capacitor charge switches, the capacitor discharge switches, the charging and discharging of the cell capacitors, and the optimization of the power output of the photovoltaic array.

8. The method recited in claim 5 wherein the photovoltaic control module incorporates a digital computer with a control algorithm.
